(19) United States
(12) Patent Application Publication
(10) Pub. No.: US 2005/0275192 A1
(43) Pub. Date: Dec. 15, 2005

(54) Motor-less vehicle

(76) Inventor: Salomon Sandro Galitzky, Spring Valley, NY (US)

Correspondence Address: JAMES RAY & ASSOCIATES, 2640 PITCAIRN ROAD, MONROEVILLE, PA, 15146, US

(21) Appl. No.: 11/198,458

(22) Filed: Aug. 5, 2005

Related U.S. Application Data
(63) Continuation-in-part of application No. 10/986,664, filed on Nov. 12, 2004, now abandoned.
(60) Provisional application No. 60/545,636, filed on Feb. 18, 2004.

(51) Int. Cl. B60J 5/06

(52) U.S. Cl. 280/400

(57) ABSTRACT

A motor-less vehicle includes a vehicle body having an interior compartment of a predetermined size and a predetermined volume for receiving and legally transporting passengers and cargo load. The interior compartment may be generally open at the top or may be closed with a roof portion. A wheel set is rigidly attached to the vehicle body for maintaining a bottom portion of the vehicle body at a predetermined distance from a ground surface. The wheel set has at least a pair of ground engaging wheels joined with an axle. A tow bar is attached to a front end portion of the vehicle body and releaseably coupled to a hitch of a motorized vehicle enabling towing of the motor-less vehicle behind the motorized vehicle. The motor-less vehicle may be equipped with climate control, entertainment, safety restraint and braking systems.

### CROSS-REFERENCE TO RELATED APPLICATIONS

This application is a Continuation-In-Part of U.S. patent application Ser. No. 10/986,664 filed Nov. 12, 2004, now abandoned.

### FIELD OF THE INVENTION

The present invention relates, in general, to a vehicle for transporting passengers and loads and, more particularly, this invention relates to a rigid vehicle structure capable of transporting passengers and loads in a towing arrangement with a motorized vehicle and the like.

### BACKGROUND OF THE INVENTION

As is generally well known, motorized passenger vehicles are only capable of legally carrying a relatively small number of passengers and a small amount of cargo load necessitating large families or small groups to use a plurality of vehicles when going on a trip or to an event. The use of sport utility vehicles or minivans has not alleviated such capacity problem. Furthermore, small businesses utilizing pick-up or other trucks to transport crews and materials to a job site often experience similar problems of needing more than one vehicle.

The need to use more than one motorized passenger vehicle increases the expenses associated with fuel and vehicle maintenance as well as increased traffic congestion and pollution. Difficulties also exist in availability and cost of parking spaces in downtown districts or at sporting and cultural events.

### SUMMARY OF THE INVENTION

The invention provides a motor-less vehicle including a vehicle body having an interior compartment of a predetermined size and a predetermined volume for receiving and legally transporting passengers and cargo load. Such vehicle body and such interior compartment are defined by a pair of side walls, front end, rear end and a bottom portion. The interior compartment may be generally open at the top or, preferably, closed with a roof portion. A wheel set is rigidly attached to the vehicle body for maintaining a bottom portion of the vehicle body at a predetermined distance above a ground surface. The wheel set has at least a pair of ground engaging wheels joined with an axle. A suspension system is provided for maintaining ride comfort. A brake member may be provided at each wheel of the wheel set. A tow bar is attached to the front end portion of the vehicle body and releaseably coupled to a hitch of a motorized vehicle enabling towing of the motor-less vehicle behind the motorized vehicle. The motor-less vehicle may be equipped with conventional climate control, entertainment, safety restraint, and communication systems.

### OBJECTS OF THE INVENTION

It is, therefore, one of the primary objects of the present invention to provide a motor-less vehicle for transporting passengers and cargo load.

Another object of the present invention is to provide a motor-less vehicle for transporting passengers and cargo load which is towable by a motorized vehicle.

Yet another object of the present invention is to provide a motor-less vehicle for transporting passengers and cargo load which offers protection from undesirable weather elements.

A further object of the present invention is to provide a motor-less vehicle for transporting passengers and cargo load which offers climatic, entertainment and ride comfort to passengers.

Yet a further object of the present invention is to provide a motor-less vehicle for transporting passengers and cargo load which is economical to manufacture.

An additional object of the present invention is to provide a motor-less vehicle for transporting passengers and cargo load which reduces traffic congestion.

Still yet another object of the present invention is to provide a motor-less vehicle for transporting passengers and cargo load which will reduce energy consumption.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a motor-less vehicle of the present invention; and

FIG. 2 is a schematic diagram of a motor-less vehicle of the present invention showing various systems provided within such motor-less vehicle.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

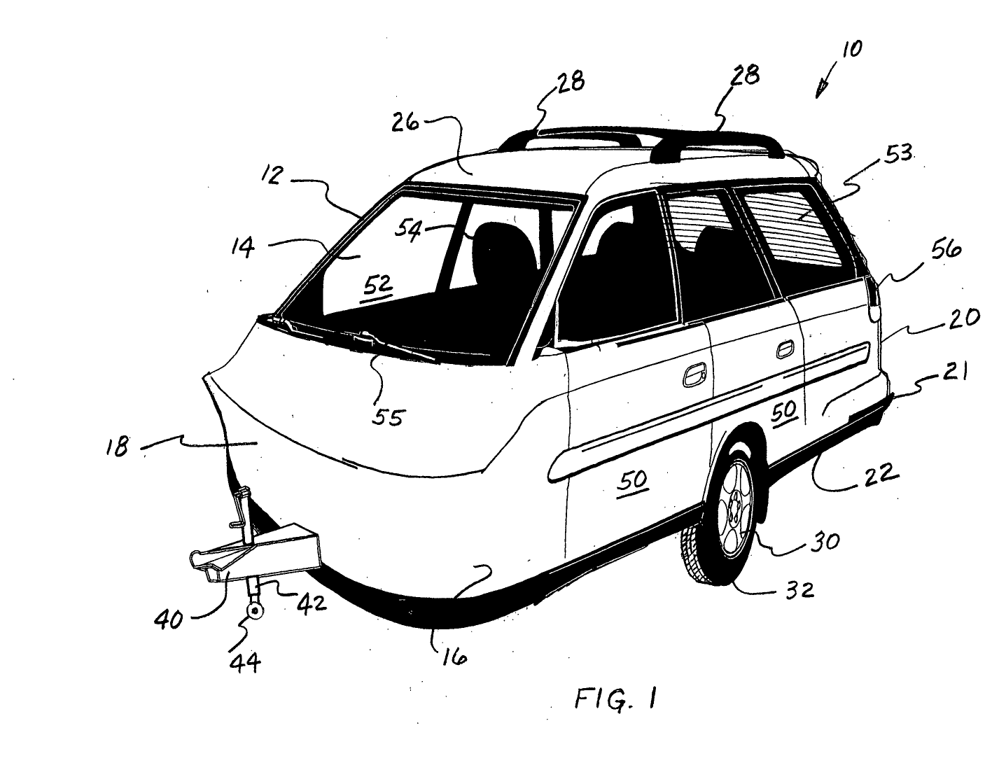

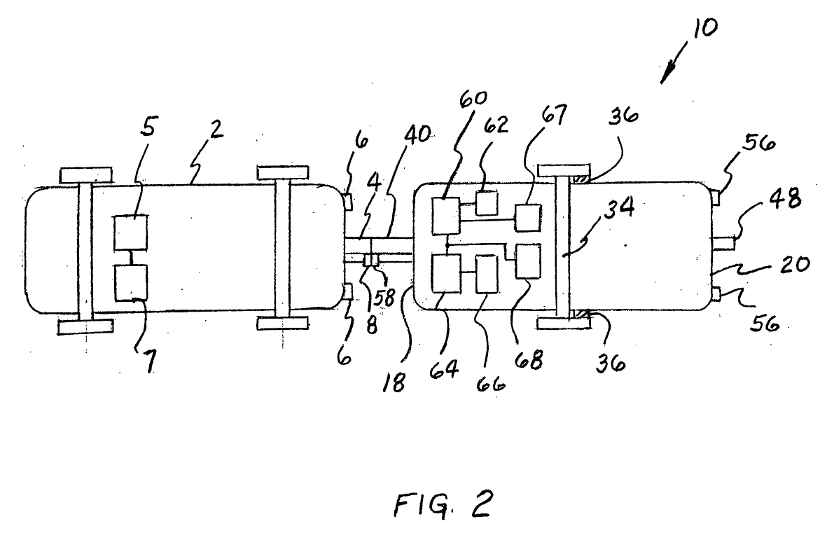

Reference is now made, to FIGS. 1-2, wherein there is shown a motor-less vehicle, generally designated 10, for transporting one of at least one passenger, cargo load and combinations thereof. Such motor-less vehicle 10 includes a vehicle body 12 having an interior compartment 14 of a predetermined size and a predetermined volume for receiving such at least one passenger, cargo load or combinations thereof. The vehicle body 12 and the interior compartment 14 are defined by a pair of side wall portions 16, a front end portion 18, a rear end portion 20 with a bumper 21 and a bottom portion 22. The vehicle body 12 has a generally open top portion 24.

In the presently preferred embodiment, the vehicle body 12 includes a roof portion 26 at least partially closing the generally open interior compartment 14 for shielding the occupants of such motor-less vehicle 10 from undesirable weather factors such as rain, wind, dust, debris and the like. At least a pair of elongated members 28 attached to an exterior surface of the roof portion 26 may be provided for carrying the cargo load externally to the vehicle body 12.

A wheel set 30 is rigidly attached to the vehicle body 12 for maintaining the bottom portion 22 of the vehicle body 12 at a predetermined distance above a ground surface. In the presently preferred embodiment, the wheel set 30 has a pair of ground engaging wheels 32 joined with an axle 34 having a longitudinal axis thereof disposed substantially parallel to the ground surface. Alternatively, additional pairs of ground engaging wheels 32 may be added depending on the size and carrying capacity of such motor-less vehicle 10.

To provide passenger comfort during movement of the motor-less vehicle 10 a conventional suspension means (not shown), capable of absorbing shocks during movement, connects the vehicle body 12 to the wheel set 30. Additionally, each wheel 32 may be provided with a brake member 36 operable by a brake means (not shown) of the motorized vehicle 2.

A means 40, such as a conventional tow bar 40, is attached to the front end portion 18 of the vehicle body 12 and releaseably coupled to a hitch 4 of a motorized vehicle 2 for towing the motor-less vehicle 10 behind the motorized vehicle 2. Such towing bar 40 may be provided with a vertically adjustable jack 42 for raising and lowering the towing bar 40 for effecting coupling of the towing bar 40 to the hitch 4 and for supporting and leveling the vehicle body 12 when the vehicle body 12 is detached from the motorized vehicle 2. A wheel 44 may be attached to the bottom end of the jack 42 for manually moving such motor-less vehicle 10. Additionally, a second hitch 48 may be attached to the rear end portion 20 for coupling at least a second motor-less vehicle 10 to be towed by the same motorized vehicle 2.

There is at least one door 50 movably mounted within a side wall portion 16, rear end portion 20 and combination thereof for enabling passenger or load access to the interior portion 14.

At least one window 52 is disposed in one of the at least one door, the vehicle body and a combination thereof, and preferably, such motor-less vehicle 10 is provided with a predetermined plurality of windows 52. At least a window 52 mounted within the front end portion 18 is provided with a window wiper and actuating mechanism assembly 53. Preferably, a window 53 mounted within the rear end portion 20 is provided with a second window wiper and actuating mechanism assembly (not shown).

At least one passenger seat 54 is provided within the interior compartment 14 of the vehicle body 12. Such passenger seat 54 may be one of any well known passenger seat styles including but not limited to stationary, removable, foldable and various combinations thereof. Such at least one seat 54 is equipped with a well known passenger safety restraint means, such as a seat belt (not shown). For additional passenger protection during accidents, at least one air inflatable bag (not shown) may be installed within such at least one door 50, side wall portion 16 and combination thereof.

In further reference to FIG. 1, there is a plurality of light sources 56 disposed at least in a rear end portion 20 of the vehicle body 12 and electrically coupled to a control means 5 of the motorized vehicle 2 and which are operable by such control means 5 substantially simultaneously to operation of light sources 6 disposed within the motorized vehicle 2. Accordingly, occupants of a vehicle driven directly behind the motor-less vehicle 10 will receive visual indication of at least one of turning, braking, reversing and stopping of such tandem of motorized vehicle 2 and motor-less vehicle 10. Furthermore, at least one of such plurality of light sources 56 will identify the presence of the motor-less vehicle 10 during darkness, nightfall or limited visibility conditions.

As best shown in FIG. 2, to enable electrical coupling of the plurality of light sources 56 to the control means 5 and a power source 7 of the motorized vehicle 2, an electrical connector 58 is attached to such towing bar 40 adjacent an outer end thereof for matingly engaging a complementary electrical connector 8 attached to the end of the hitch 4.

Alternatively, a power source 60, such as a well known battery 60, may be disposed within the vehicle body 12 for providing electrical power to the plurality of light sources 56. Preferably, such battery 60 is rechargeable and the motor-less vehicle 10 includes means 62 operable from rotation of the wheel set 30 for recharging such battery 60.

In further reference to FIG. 2, to provide passenger comfort during occupancy of such motor-less vehicle 10, there is a climate control means 64 disposed in communication with the interior compartment 14 of the vehicle body 12 and at least one control member 66 disposed within the interior compartment 14 for operating the climate control means 64. The climate control means 64 may be electrically coupled to one of the electrical power source 7 disposed within the motorized vehicle 2, the electrical power source 60 disposed within the motor-less vehicle 10 and a combination thereof.

The climate control means 64 provides for one of cooling the interior compartment 14, heating the interior compartment 14, defrosting such at least one window 52 and window 52, and various combinations thereof.

An entertainment means 67, such as a radio, CD player, DVD player and various combinations thereof, and at least one display connected to such DVD player, may be disposed within a predetermined portion of the interior compartment 14 and electrically coupled to one of the electrical power source 7, the electrical power source 60 and combinations thereof.

Furthermore, a well known communication system 68, such as intercom, may be provided for enabling at least a voice communication between occupants in the motorized vehicle 2 and motor-less vehicle 10. Such intercom 68 will include a first member (not shown) disposed within the interior compartment 14 and a second member disposed within an interior compartment of the motorized vehicle 2.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. A motor-less vehicle comprising:
(a) a vehicle body having an interior compartment of a predetermined size and a predetermined volume for receiving and legally transporting one of at least one passenger, cargo load and combination thereof, said interior compartment having a generally open top portion;
(b) a wheel set rigidly attached to said vehicle body for maintaining a bottom portion of said vehicle body at a predetermined distance above ground level, said wheel set having at least a pair of ground engaging wheels joined with an axle having a longitudinal axis thereof disposed substantially parallel to said ground level;
(c) means attached to a front end portion of said vehicle body and releaseably coupled to a hitch of a motorized vehicle for enabling towing of said motor-less vehicle behind said motorized vehicle.

2. The vehicle, according to claim 1, wherein said towing means is a tow bar.

3. The vehicle, according to claim 2, wherein said tow bar includes vertically adjustable means for raising and lowering said tow bar for effecting coupling of said tow bar to said hitch and for supporting and leveling said vehicle body when said vehicle body is detached from said motorized vehicle.

4. The vehicle, according to claim 1, wherein said vehicle includes at least one passenger seat disposed within said interior compartment of said vehicle body.

5. The vehicle, according to claim 4, wherein said passenger seat is one of stationary, removable, foldable and various combinations thereof.

6. The vehicle, according to claim 1, wherein said vehicle further includes at least one door disposed within a side wall portion, rear end portion and a combination thereof for receiving said one of at least one passenger, load and combination thereof.

7. The vehicle, according to claim 6, wherein said vehicle further includes at least one window disposed in one of said at least one door, said vehicle body and a combination thereof.

8. The vehicle, according to claim 1, wherein said vehicle body includes a roof portion at least partially closing said generally open interior compartment.

9. The vehicle, according to claim 8, wherein said vehicle further includes at least a pair of elongated members attached to exterior of said roof portion of said vehicle body for carrying said load externally to said vehicle body.

10. The vehicle, according to claim 1, wherein said vehicle further includes a rechargeable electrical power source disposed within said vehicle body.

11. The vehicle, according to claim 10, wherein said vehicle further includes means coupled to said wheel set for recharging said rechargeable electrical power source during movement of said vehicle.

12. The vehicle, according to claim 10, wherein said vehicle further includes means attached to an outer end of said towing means for enabling electrical coupling of said motor-less vehicle to one of a power source, control means and combination thereof of said motorized vehicle.

13. The vehicle, according to claim 1, wherein said vehicle further includes a plurality of light sources disposed at least in a rear end portion of said vehicle body and electrically coupled to a control means of said motorized vehicle, said control means of said motorized vehicle operates said plurality of light sources substantially simultaneously to operation of light sources disposed on said motorized vehicle.

14. The vehicle, according to claim 1, wherein said vehicle further includes a climate control means disposed in communication with said interior compartment of said vehicle body and at least one control member disposed within said interior compartment for operating said climate control means, said climate control means electrically coupled to one of a first electrical power source disposed within said motorized vehicle, second electrical power source disposed within said motor-less vehicle and combination thereof, said climate control means is for one of cooling, heating, defrosting and various combinations thereof.

15. The vehicle, according to claim 1, wherein said vehicle further includes a suspension means connecting said vehicle body to said wheel set and capable of absorbing shocks during movement of said motor-less vehicle.

16. The vehicle, according to claim 1, wherein each of said pair of wheels is provided with a brake member operable by a brake means of said motorized vehicle.

17. The vehicle, according to claim 1, wherein said vehicle further includes at least one entertainment means disposed within said interior compartment of said vehicle body and electrically coupled to one of a first electrical power source disposed within said motorized vehicle, a second electrical power source disposed within said motor-less vehicle and combination thereof.

18. The vehicle, according to claim 1, wherein said vehicle further includes a first communication means at least partially disposed within said interior compartment of said motor-less vehicle for enabling at least a voice communication with a second communication means disposed within said motorized vehicle.

19. The vehicle, according to claim 1, wherein said vehicle further includes at least one windshield wiper and actuator assembly disposed adjacent one of a windshield mounted within said front end portion, window mounted within a rear end portion of said vehicle body and combination thereof.

20. An arrangement for transporting one of a larger number of passengers, a larger amount of a cargo load and a combination thereof, said arrangement comprising:
(a) a motorized master vehicle having ground engaging wheels; and
(b) at least one motor-less slave vehicle coupled in tandem to said motorized master vehicle and towed thereby, said at least one motor-less slave vehicle comprising:
(i) a vehicle body having an interior compartment of a predetermined size and a predetermined volume for receiving and legally transporting one of at least one passenger, said cargo load and a combination thereof,
(ii) a wheel set rigidly attached to said vehicle body for maintaining a bottom portion of said vehicle body at a predetermined distance above ground surface, said wheel set having at least a pair of ground engaging wheels joined with an axle having a longitudinal axis thereof disposed substantially parallel to said ground surface, and
(iii) means attached to a front end portion of said vehicle body and releaseably coupled to a hitch of said motorized master vehicle for enabling towing of said at least one motor-less slave vehicle body behind said motorized master vehicle.
